(19) United States
(12) Patent Application Publication
(10) Pub. No.: US 2007/0124064 A1
(43) Pub. Date: May 31, 2007

(54) Map information updating system, central apparatus, map information updating method and recording medium

(75) Inventors: Masayuki Fukui, Kawasaki (JP); Tatsuro Matsumoto, Kawasaki (JP); Yasuhide Matsumoto, Kawasaki (JP); Satoru Watanabe, Kawasaki (JP); Ai Yano, Kawasaki (JP); Kazuo Sasaki, Kawasaki (JP); Eiichi Takahashi, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/390,170

(22) Filed: Mar. 28, 2006

(30) Foreign Application Priority Data
Nov. 30, 2005 (JP) 2005-346119

(51) Int. Cl. G01C 21/32

(52) U.S. Cl. 701/208; 340/995.1

(57) ABSTRACT

Obtaining a map update information related to a change caused by a new establishment or razing of a road or facility or the like, only in a case that a re-confirm is possible from a different information source, update a map information. Each of terminal apparatuses obtains a position information, transmits the obtained position information to the central apparatus, and obtains the map update information related to the change in the facility or road, and then transmits the obtained map update information to the central apparatus. The central apparatus receives the position information and the map update information, and compares with a map update information, and consequently judges whether or not there is any difference from the map information. If there is the difference, this transmits a confirm request to a different terminal apparatus, and when receiving a confirm report indicative of the normality, updates the stored map information.

### CROSS-REFERENCE TO RELATED APPLICATIONS

This Nonprovisional application claims priority under 35 U.S.C. §119(a) on Patent Application No. 2005-346119 filed in Japan on Nov. 30, 2005, the entire contents of which are hereby incorporated by reference.

### BACKGROUND OF THE INVENTION

The present invention relates to a map information updating system, a central apparatus and a map information updating method which, when receiving a map update information related to a change in a facility or road that is obtained by a mobile terminal apparatus such as a car navigation system, a portable telephone and the like, request a neighborhood different mobile terminal apparatus to confirm it and then update the map information only if this is judged to be normal, and a recording medium which records a computer program that can be executed by the central apparatus.

The recent car navigation system has the various functions based on an accurate identification of a car position through GPS, and the further accuracy is also required for the map information installed in the navigation system. However, the map information is originally changed from hour to hour. Traditionally, an employee of a company that prepares the map information carries out a cyclic patrol and the like and collects the facility information with regard to a newly established facility or a razed facility or the like, or the road information with regard to a newly established road or a closed road or the like. Thus, until they are reflected in the map information and distributed as an article, there is the time gap of approximately several months, and there is a problem that the map information and the actual condition are separated.

In order to solve the problem, for example, Japanese Patent Application Laid Open No. 2001-194163 discloses a map information updating method, which matches a stored map information with a current running information, and collects the road data that is not noted in the map information, and then uses the information detected as the non-noted road data and consequently updates the map information. The method of Japanese Patent Application Laid Open No. 2001-194163, when recognizing that a car is running on the road which is not noted in the map information, uploads the road information to a host computer, and updates the map information stored on the host computer.

Also, Japanese Patent Application Laid Open No. 11-351888 discloses a navigation apparatus, which adds a new facility information to a map database, in accordance with a detection value of a position sensor installed in a car, a car state sensor, a facility detection sensor based on a picture data or the like. In Japanese Patent Application Laid Open No. 11-351888, a user who discovers a new facility can update the map database by using the information with regard to a newly established facility without any stop for the attention to the car, and can update the map information in substantially real time.

### BRIEF SUMMARY OF THE INVENTION

The present invention is proposed in view of the above-mentioned circumstances. It is therefore an object of the present invention to provide the map information updating system, the central apparatus, the map information updating method and the recording medium which update the map information only when obtaining the map update information related to the change caused by a newly established or razed road or facility, or only when the re-confirm is possible from a different information source.

In order.to attain the above-mentioned object, a map information updating system according to the first invention is characterized by a map information updating system which includes: a plurality of terminal apparatuses for obtaining a map update information related to a change in a facility or road; and a central apparatus for obtaining the map update information from the plurality of terminal apparatuses and updating a stored map information, wherein each terminal apparatus comprises a device for obtaining a position information with regard to a position at which the terminal apparatus exists; a device for transmitting the obtained position information to the central apparatus; an obtaining device for obtaining the map update information; and a device for transmitting the obtained map update information to the central apparatus, and the central apparatus comprises: a device for receiving the position information and map update information; a device for comparing the received position information and map update information and the stored map information and judging whether or not there is any difference from the map information; a device for transmitting a confirm request as to whether or not the map update information is normal, to a different terminal apparatus located within a predetermined range with respect to a position of a terminal apparatus that is a transmission source of the position information and map update information, in case for judging that there is any difference; and a device for updating the stored map information, in case for receiving a confirm report indicative of the normality for the confirm request from the different terminal apparatus,.

Also, a map information updating system according to a second invention is characterized by a map information updating system which includes: a plurality of terminal apparatuses for obtaining a map detection information related to a detection of an existing facility or road; and a central apparatus for obtaining the map detection information from the plurality of terminal apparatuses and updating a stored map information, wherein each terminal apparatus comprises: a device for obtaining a position information with regard to a position at which the terminal apparatus exists; a device for transmitting the obtained position information to the central apparatus; an obtaining device for obtaining the map detection information; and a device for transmitting the obtained map detection information to the central apparatus, and the central apparatus comprises: a device for receiving the position information and map detection information; a history information storing device for storing the received position information and map detection information in time series; a device for comparing the stored position information and map detection information and the stored map information and judging whether or not there is any difference from the map information; a device for transmitting a confirm request as to whether or not the map detection information is normal, to a different terminal apparatus located within a predetermined range with respect to a position of a facility or road of the stored map information, in case for judging that there is any difference; and a device for updating the stored map information, in case for receiving a confirm report indicative of the normality for the confirm request from the different terminal apparatus.

Also, a map information updating system according to a third invention is characterized in that in the first or second invention, the terminal apparatus comprises: a device for storing the obtained map update information or map detection information in a storing device; and a device for transmitting the stored map update information or map detection information to the central apparatus at a predetermined temporal interval.

Also, a map information updating system according to a fourth invention is characterized in that in the first or second invention, the terminal apparatus comprises: a picture imaging unit for imaging a peripheral picture; and a detecting unit for detecting a change in a facility or road in accordance with the imaged picture, and the detecting unit comprises: a device for storing a picture in time series while correlating to the position information; a device for judging whether or not an immediately stored picture and an obtained picture are coincident; and a device for transmitting the obtained picture and position information to the central apparatus, in case for judging that they are not coincident,.

Also, a map information updating system according to a fifth invention is characterized by a map information updating system which includes: a plurality of terminal apparatuses for obtaining a map update information related to a change in a facility or road; and a central apparatus for obtaining the map update information from the plurality of terminal apparatuses and updating a stored map information, wherein each terminal apparatus comprise a processor capable for performing the steps of: obtaining a position information with regard to a position at which a terminal apparatus exists; transmitting the obtained position information to the central apparatus; obtaining the map update information; and transmitting the obtained map update information to the central apparatus, and the central apparatus comprises a processor capable for performing the steps of receiving the position information and map update information; comparing the received position information and map update information and the stored map information and judging whether or not there is any difference from the map information; in case for judging that there is any difference, transmitting a confirm request as to whether or not the map update information is normal, to a different terminal apparatus located within a predetermined range with respect to a position of a terminal apparatus, that is a transmission source of the position information and map update information; and in case for receiving a confirm report indicative of the normality for the confirm request from the different terminal apparatus, updating the stored map information.

Also, a map information updating system according to a sixth invention is characterized by a map information updating system which includes: a plurality of terminal apparatuses for obtaining a map detection information related to a detection of an existing facility or road; and a central apparatus for obtaining the map detection information from the plurality of terminal apparatuses and updating a stored map information, wherein each terminal apparatus comprises a processor capable for performing the steps of: obtaining a position information with regard to a position at which the terminal apparatus exists; transmitting the obtained position information to the central apparatus; obtaining the map detection information; and transmitting the obtained map detection information to the central apparatus, and the central apparatus comprises a processor capable for performing the steps of receiving the position information and map detection information; storing the received position information and map detection information in time series; comparing the stored position information and map detection information and the stored map information and judging whether or not there is any difference from the map information; in case for judging that there is any difference, transmitting a confirm request as to whether or not the map detection information is normal, to a different terminal apparatus located within a predetermined range with respect to a position of a facility or road of the stored map information; and in case for receiving a confirm report indicative of the normality for the confirm request from the different terminal apparatus, updating the stored map information.

Also, a map information updating system according to a seventh invention is characterized in that in the fifth or sixth invention, the terminal apparatus comprises the processor further capable for performing the steps of storing the obtained map update information or map detection information in a storing device; and transmitting the stored map update information or map detection information to the central apparatus at a predetermined temporal interval.

Also, a map information updating system according to an eighth invention is characterized in that in the fifth or sixth invention, the terminal apparatus further comprises: a picture imaging unit for imaging a peripheral picture; and a detecting unit for detecting a change in a facility or road in accordance with the imaged picture, and the detecting unit comprises the processor further capable for performing the steps of storing a picture in time series while correlating to the position information; judging whether or not an immediately stored picture and an obtained picture are coincident; and if judging that they are not coincident, transmitting the obtained picture and position information to the central apparatus.

Also, a central apparatus according to a ninth invention is characterized by a central apparatus which obtains, from a plurality of terminal apparatuses for obtaining a map update information related to a change in a facility or road, the map update information and updates a stored map information, comprises: a device for receiving position information with regard to positions at which the plurality of terminal apparatuses exist and the map update information; a device for comparing the received position information and map update information and the stored map information and judging whether or not there is any difference from the map information; a device for transmitting a confirm request as to whether or not the map update information is normal, to a different terminal apparatus located within a predetermined range with respect to a position of a terminal apparatus that is a transmission source of the position information and map update information; and a device for updating the stored map information in case for judging that there is any difference, in case for receiving a confirm report indicative of the normality for the confirm request from the different terminal apparatus,.

Also, a central apparatus according to a tenth invention is characterized by a central apparatus which obtains, from a plurality of terminal apparatuses for obtaining a map detection information related to a detection of an existing facility or road, the map detection information, and updates a stored map information, and comprises: a device for receiving position information with regard to positions at which the plurality of terminal apparatuses exist and the map detection information; a history information storing device for storing the received position information and map detection information in time series; a device for comparing the stored position information and map detection information and the stored map information and judging whether or not there is any difference from the map information; a device for transmitting a confirm request as to whether or not the map detection information is normal, to a different terminal apparatus located within a predetermined range with respect to a position of a facility or road of the stored map information, in case for judging that there is any difference; and a device for updating the stored map information, in case for receiving a confirm report indicative of the normality for the confirm request from the different terminal apparatus.

Also, a central apparatus according to an eleventh invention is characterized by a central apparatus which obtains, from a plurality of terminal apparatuses for obtaining a map update information related to a change in a facility or road, the map update information and updates a stored map information, wherein the central apparatus comprises a processor capable for performing the steps of receiving position information with regard to positions at which the plurality of terminal apparatuses exist and the map update information; comparing the received position information and map update information and the stored map information and judging whether or not there is any difference from the map information; in case for judging that there is any difference, transmitting a confirm request as to whether or not the map update information is normal, to a different terminal apparatus located within a predetermined range with respect to a position of a terminal apparatus that is a transmission source of the position information and map update information; and in case for receiving a confirm report indicative of the normality for the confirm request from the different terminal apparatus, updating the stored map information.

Also, a central apparatus according to a twelfth invention is characterized by a central apparatus which obtains, from a plurality of terminal apparatuses for obtaining a map detection information related to a detection of an existing facility or road, the map detection information and updates a stored map information, wherein the central apparatus comprises a processor capable for performing the steps of receiving position information with regard to positions at which the plurality of terminal apparatuses exist and the map detection information; storing the received position information and map detection information in time series; comparing the stored position information and map detection information and the stored map information and judging whether or not there is any difference from the map information; in case for judging that there is any difference, transmitting a confirm request as to whether or not the map detection information is normal, to a different terminal apparatus located within a predetermined range with respect to a position of a facility or road of the stored map information; and in case for receiving a confirm report indicative of the normality for the confirm request from the different terminal apparatus, updating the stored map information.

Also, a map information updating method according to a thirteenth invention is characterized by a map information updating method which uses: a plurality of terminal apparatuses for obtaining a map update information related to a change in a facility or road; and a central apparatus for obtaining the map update information from the plurality of terminal apparatuses and updating a stored map information, wherein each terminal apparatus comprises the steps of: obtaining a position information with regard to a position at which each terminal apparatus exists; transmitting the obtained position information to the central apparatus; obtaining the map update information; and transmitting the obtained map update information to the central apparatus, and the central apparatus comprises the steps of receiving the position information and map update information; comparing the received position information and map update information and the stored map information and judging whether or not there is any difference from the map information; in case for judging that there is any difference, transmitting a confirm request as to whether or not the map update information is normal, to a different terminal apparatus located within a predetermined range with respect to a position of a terminal apparatus that is a transmission source of the position information and map update information; and in case for receiving a confirm report indicative of the normality for the confirm request from the different terminal apparatus, updating the stored map information.

Also, a map information updating method according to a fourteenth invention is characterized by a map information updating method which uses: a plurality of terminal apparatuses for obtaining a map detection information related to a detection of an existing facility or road; and a central apparatus for obtaining the map detection information from the plurality of terminal apparatuses and updating a stored map information, wherein each terminal apparatus comprises the steps of: obtaining a position information with regard to a position at which the terminal apparatus exists; transmitting the obtained position information to the central apparatus; obtaining the map detection information; and transmitting the obtained map detection information to the central apparatus, and the central apparatus comprises the steps of: receiving the position information and map detection information; storing the received position information and map detection information in time series; comparing the stored position information and map detection information and the stored map information and judging whether or not there is any difference from the map information; in case for judging that there is any difference, transmitting a confirm request as to whether or not the map detection information is normal, to a different terminal apparatus located within a predetermined range with respect to a position of a facility or road of the stored map information; and in case for receiving a confirm report indicative of the normality for the confirm request from the different terminal apparatus, updating the stored map information.

Also, a recording medium according to a fifteenth invention is characterized by a recording medium for recording a computer-executable computer program, which obtains a map update information related to a change in a facility or road from an outside and updates a stored map information, wherein the computer program stored in the recording medium comprise the steps of causing the computer to receive a position information with regard to a position and the map update information from the outside; causing the computer to compare the received position information and map update information and the stored map information and judge whether or not there is any difference from the map information; causing the computer to transmit a confirm request as to whether or not the map update information is normal, to a different transmission destination located within a predetermined range with respect to a position of a transmission source of the position information and map update information, in case for judging that there is any difference; and causing the computer to update the stored map information, in case for receiving a confirm report indicative of the normality for the confirm request from the different transmission destination.

Also, a recording medium according to a sixteenth invention is characterized by a recording medium for recording a computer-executable computer program, which obtains, from a plurality of terminal apparatuses for obtaining a map detection information related to a detection of an existing facility or road, the map detection information, and updates a stored map information, wherein the computer program stored in the recording medium comprises the steps of: causing the computer to receive position information with regard to positions at which the plurality of terminal apparatuses exist and the map detection information; causing the computer to store the received position information and map detection information in time series; causing the computer to compare the stored position information and map detection information and the stored map information and judge whether or not there is any difference from the map information; causing the computer to transmit a confirm request as to whether or not the map detection information is normal, to a different terminal apparatus located within a predetermined range with respect to a position of a facility or road of the stored map information, in case for judging that there is any difference, and causing the computer to update the stored map information, in case for receiving a confirm report indicative of the normality for the confirm request from the different terminal apparatus.

In the first invention, the fifth invention, the ninth invention, the eleventh invention, the thirteenth invention and the fifteenth invention, the plurality of terminal apparatuses that obtain the map update information related to the change in the facility or road obtain the position information with regard to the existence position and transmit the obtained position information to the central apparatus. On the other hand, the map update information is obtained, and the obtained map update information is also transmitted to the central apparatus. The central apparatus receives the position information and the map update information, compares the received position information and map update information and the stored map information, and judges whether or not there is any difference from the map information. If judging that both of them are different, this transmits the confirm request as to whether or not the map update information is normal, to the different terminal apparatus located within the predetermined range with respect to the position of the terminal apparatus that is the transmission source of the position information and the map update information, and when receiving the confirm report indicative of the normality for the confirm report from the different terminal apparatus, updates the stored map information. Consequently, even if obtaining the map update information related to the change in the facility or road, this does not change the map information immediately. Then, this transmits the confirm request as to whether or not there is the actual change to the different terminal apparatus, and updates the map information if there is the actual change, namely, only if the change information is defined to be normal. Thus, it is possible to protect in advance the generation of the trouble that the map information stored in the central apparatus is frequently updated on the basis of the erroneous map update information, and it is possible to update the map information in the schematically real time while maintaining the accuracy of the map information.

In the second invention, the sixth invention, the tenth invention, the twelfth invention, the fourteenth invention and the sixteenth invention, this stores the position information and the map detection information in the time series and compares the received position information and map detection information and the stored position information. If the information related to the facility or road stored in the map information is not included in the position information and map detection information which are stored in the time series, the corresponding facility or road is judged to be razed. In this case, the confirm request as to whether or not the map update information is normal is transmitted to the different terminal apparatus located within the predetermined range with respect to the position of the razed facility or road. Consequently, the fact that the facility or road located at the predetermined position is razed is detected from the fact that it is not included in the map detection information, and the map information is not updated immediately. Then, the confirm request as to whether or not it is actually razed is transmitted to the different terminal apparatus. Thus, before the map information is discarded, the information as to whether or not the change is really executed can be obtained from the different terminal apparatus. Hence, it is possible to protect in advance the generation of the trouble that the map information stored in the central apparatus is frequently updated on the basis of the erroneous map update information, and it is possible to update the map information in the schematically real time while maintaining the accuracy of the map information.

In the third invention and the seventh invention, the terminal apparatus stores the obtained map update information or map detection information in the storing device and transmits the stored map update information or map detection information to the central apparatus at the predetermined temporal interval. Thus, since the map update information updated in the terminal apparatus or the new map detection information detected in the terminal apparatus is transmitted to the central apparatus for each constant time, the map information stored in the central apparatus can be made into the information where the newest situation is reflected for each constant time.

In the fourth invention and the eighth invention, the terminal apparatus includes the picture imaging unit for imaging the peripheral picture and the detecting unit for detecting the change in the facility or road in accordance with the imaged picture. The detecting unit stores the picture in the time series while correlating to the position information and judges whether or not the immediately stored picture and the obtained picture, and if judging that they are not coincident, transmits the obtained picture and position information. Thus, only if the picture on which the same facility or road is imaged is changed, the newly imaged picture is transmitted to the central apparatus. Hence, the picture on which the facility or road is imaged can be always maintained at the newest situation.

According to the first invention, the fifth invention, the ninth invention, the eleventh invention, the thirteenth invention or the fifteenth invention, even in the case of the obtainment of the map update information related to the change in the facility or road, the map information is not immediately changed. Then, the confirm request as to whether or not there is the actual change is transmitted to the different terminal apparatus. Only if the actual change is confirmed, the map information is updated. Thus, it is possible to protect in advance the generation of the trouble that the map information stored in the central apparatus is frequently updated on the basis of the erroneous map update information, and it is possible to update the map information in the schematically real time while maintaining the accuracy of the map information.

According to the second invention, the sixth invention, the tenth invention, the twelfth invention, the fourteenth invention or the sixteenth invention, the fact that the facility or road located at the predetermined position is razed is detected from the fact that it is not included in the map detection information, and the map information is not immediately updated. Then, the confirm request as to whether or not the facility or road is actually razed is transmitted to the different terminal apparatus. Thus, before the map information is discarded, the information as to whether or not the change is really executed can be obtained from the different terminal apparatus. Thus, it is possible to protect in advance the generation of the trouble that the map information stored in the central apparatus is frequently updated on the basis of the erroneous map update information, and it is possible to update the map information in the schematically real time while maintaining the accuracy of the map information.

According to the third invention or the seventh invention, the map update information updated in the terminal apparatus, or the new map detection information detected in the terminal apparatus is transmitted to the central apparatus for each constant time. Thus, the map information stored in the central apparatus can be made into the information where the newest situation is reflected for each constant time.

According to the fourth invention or the eighth invention, only when the picture on which the same facility or road is imaged is changed, the newly imaged picture is transmitted to the central apparatus. Thus, the picture on which the facility or road is imaged can be always maintained at the newest situation.

The above and further objects and features of the invention will more fully be apparent from the following detailed description with accompanying drawings.

### BRIEF DESCRIPTION OF THE SEVERAL VIEWS OF THE DRAWINGS

FIG. 1 is a block diagram showing a configuration of a map information updating system according to a first embodiment of the present invention;

FIG. 2 is a block diagram showing a configuration of a terminal apparatus of the map information updating system according to the first embodiment of the present invention;

FIG. 3 is a flowchart showing a processing procedure of CPU of a central apparatus of the map information updating system according to the first embodiment of the present invention;

FIG. 4 is an exemplification view of a displaying screen configuration of a navigation terminal apparatus;

FIG. 5 is an exemplification view of a data configuration of a facility information table stored in a map information storing unit;

FIG. 6 is an exemplification view of a data configuration of a position information of each terminal apparatus stored in the map information storing unit;

FIG. 7 is an exemplification view of a displaying screen configuration of a navigation terminal apparatus;

FIG. 8 is a block diagram showing a configuration of a map information updating system according to a second embodiment of the present invention;

FIG. 9 is a flowchart showing a processing procedure of CPU of a central apparatus in the map information updating system according to the second embodiment of the present invention;

FIG. 10 is an exemplification view of a data configuration of a history information stored in a history information storing unit;

FIG. 11 is a block diagram showing a configuration of a terminal apparatus in a map information updating system according to a third embodiment of the present invention;

FIG. 12 is a flowchart showing a processing procedure of a calculating process of the terminal apparatus in the map information updating system according to the third embodiment of the present invention;

FIG. 13 is a flowchart showing a processing procedure of CPU of a central apparatus in a map information updating system according to a fourth embodiment of the present invention; and

FIG. 14 is a flowchart showing of a processing procedure of CPU of a central apparatus in a map information updating system according to a fifth embodiment of the present invention.

### DETAILED DESCRIPTION OF THE INVENTION

In the above-mentioned Japanese Patent Application Laid Open No. 2001-194163 and Japanese Patent Application Laid Open No. 8-146984, when the information indicating the new establishment of a road or facility is obtained, without any special confirm, the map information is updated, and the map database is updated. That is, under assumption that the obtained information is always the normal information, the map information or map database that is used by many users is updated. However, even in the case of the obtainment of erroneous information, the map information or map database is updated. Thus, there is the problem that the map information to be used by the many users is updated to an erroneous state.

Also, they are limited to the obtainment of the information indicating that the road or facility is newly established. For example, when the facility is razed, the information of the case that the road is under construction or the like cannot be obtained. Also, the removal of the road or facility from the map information without any confirm is difficult from the viewpoint of the maintenance of the accuracy of the map information.

The present invention is proposed in view of the above-mentioned circumstance. Therefore, the object of the present invention is to provide the map information updating system, the central apparatus, the map information updating method and the recording medium which, when obtaining the map update information related to the change caused by the new establishment, razing or the like of the road or facility, update the map information only if the re-confirm is possible from a different information source. Then, this is embodied by the following embodiments.

### FIRST EMBODIMENT

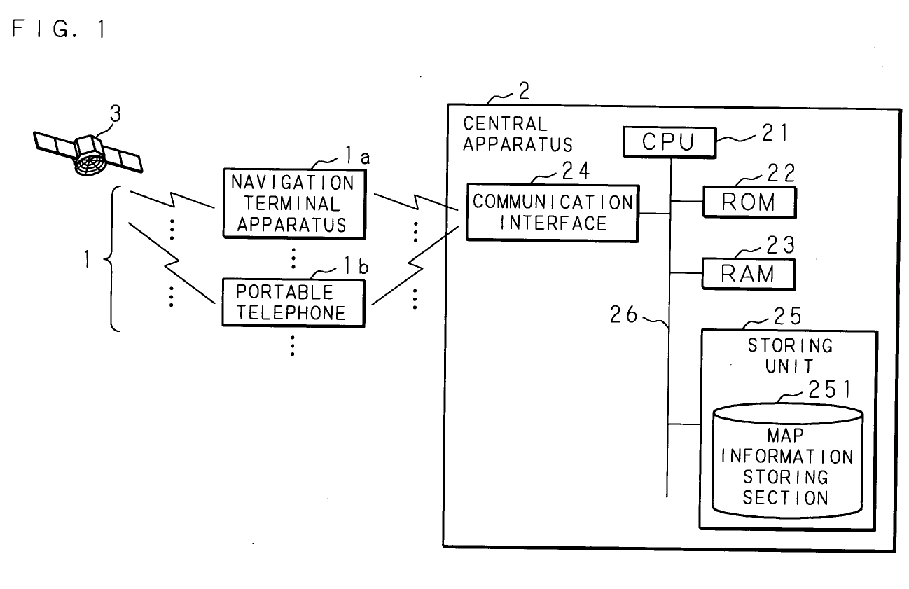

The present invention will be described below in detail with reference to the drawing showing the first embodiment. FIG. 1 is a block diagram showing the configuration of the map information updating system according to the first embodiment of the present invention. The map information updating system according to the first embodiment is provided with: terminal apparatuses 1, 1 - - - , such as navigation terminal apparatuses 1a, 1a - - - installed in cars, portable telephones 1b, 1b . . . carried by walkers and the like; and a central apparatus 2 that can wirelessly communicate with the terminal apparatuses 1, 1 - - - . Also, the terminal apparatuses 1, 1 - - - can transmit or receive a signal to and from a GPS (Global Positioning System) satellite 3 and can obtain a latitude and a longitude as a position information. By the way, the terminal apparatus 1 is not limited to the navigation terminal apparatus la or the portable telephone 1b. If it is the mobile terminal apparatus, it is not especially limited.

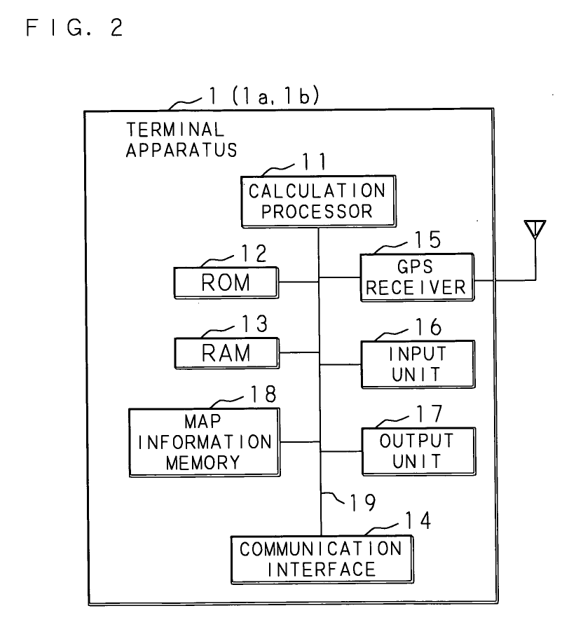

FIG. 2 is a block diagram showing the configuration of the terminal apparatus 1 in the map information updating system according to the first embodiment of the present invention. The terminal apparatus 1 includes at least an calculation processor 11 such as MPU, DSP or the like, a ROM 12, a RAM 13, a communication interface 14 that can carry out a radio communication, a GPS receiver 15, an input unit 16, an output unit 17 and a map information memory 18 for storing the map information.

The calculation processor 11 is connected through an inner bus 19 to the respective units of the hardware of the terminal apparatus 1 and controls the respective units of the hardware and also executes various software functions, in accordance with: a processing program stored in the ROM 12; a program for receiving or detecting an update information of, for example, a facility or road located in the periphery; a program for transmitting the update information of the received or detected facility or road to the central apparatus 2; a program for receiving a confirm request of the update information of the facility or road from the central apparatus 2; a program for transmitting a confirm report corresponding to the confirm request; and the like.

The ROM 12 is composed of flash memories and the like and stores the processing program necessary for the function as the terminal apparatus 1. The RAM 13 is composed of SRAM and the like and stores the transient data generated when the software is executed. The map information memory 18 is composed of HDD, a CD-ROM apparatus, a flash memory, SRAM and the like, and stores all of the map information over a wide range, or partially downloads and stores the map information in the range that is judged to be a neighbor territory by the central apparatus 2 in accordance with the latitude or longitude.

The communication interface 14 uses, for example, a multi-channel access radio method, and carries out a radio communication with the central apparatus 2. The calculation processor 11 transmits the update information of the received or detected facility or road through the communication interface 14, and receives the confirm request of the update information of the facility or road, and then transmits the confirm report corresponding to the confirm request. The GPS receiver 15 transmits and receives a signal to and from the GPS satellite 3 and consequently obtains a current position of the terminal apparatus 1 as latitude and longitude information.

The input unit 16 is a number button, a function button or the like and sends the instruction of, for example, the transmission of the confirm report to the central apparatus 2, to the calculation processor 11, in accordance with the instruction of the output unit 17 for displaying and outputting the information. The output unit 17 is the display having a liquid crystal display panel and may be integrated with the input unit 16 under the condition of receiving the input through a finger, a touch pen or the like.

The central apparatus 2 includes: at least a CPU 21, a ROM 22, a RAM 23, a communication interface 24 that can carry out a radio communication, and a storing unit 25 for collectively storing the map information. The map information together with the information with regard to the facility or road that is correlated to the position information, such as the latitude, the longitude and the like, is stored in a map information storing section 251 of the storing unit 25.

The CPU 21 is connected through an inner bus 26 to the respective units of the hardware in the central apparatus 2, and controls the respective units of the hardware, and executes various software functions, in accordance with a processing program stored in the ROM 22, a program for receiving, for example, the update information of the facility or road from the terminal apparatuses 1, 1 - - - , a program for transmitting the confirm request of the update information of the facility or road, a program for receiving the confirm report, a program for updating the map information; and the like.

The ROM 22 is composed of flash memories and the like and stores the processing program necessary for the function as the central apparatus 2. The RAM 23 is composed of SRAM and the like and stores the transient data generated when the software is executed. The storing unit 25 is composed of a hard disc and the like and stores the map information including the information with regard to the facility or road that is correlated to the position information of latitude, longitude and the like.

The communication interface 24 uses, for example, the multi-channel access radio method, and carries out a radio communication with the terminal apparatuses 1, 1 - - - . The CPU 21 receives the update information of the facility or road through the communication interface 24, and transmits to a terminal apparatus different from the terminal apparatus that receives the confirm request of the update information of the facility or road, and then updates the map information if receiving the confirm report corresponding to the confirm request.

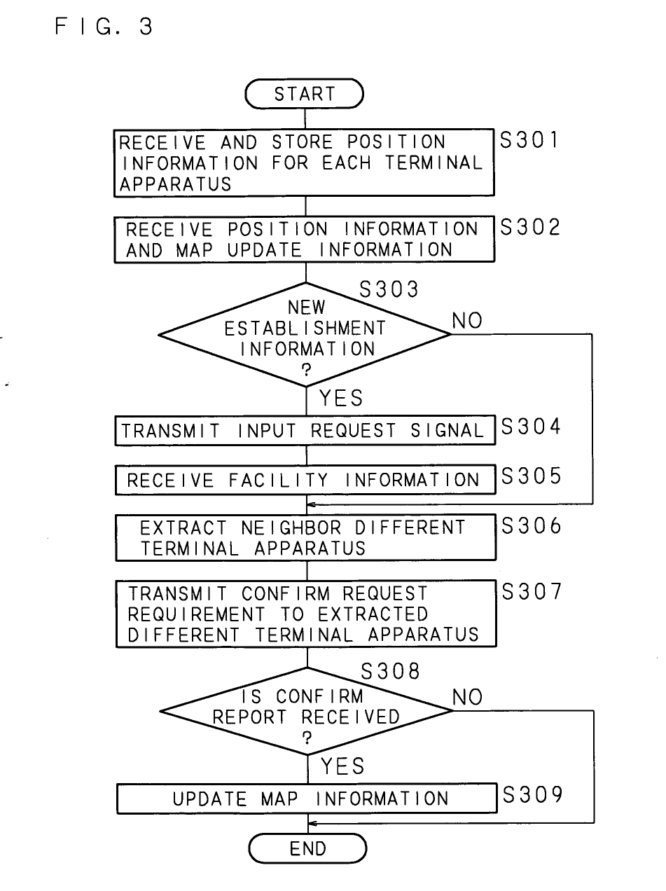

The operation of the map information updating system according to the first embodiment having the foregoing configuration is explained. Hereafter, this is explained under assumption that the terminal apparatus 1 is the navigation terminal apparatus 1a in a car navigation system installed in a car. FIG. 3 is a flowchart showing the processing procedure of the CPU 21 of the central apparatus 2 in the map information updating system according to the first embodiment of the present invention.

While the user is driving the car, the calculation processor 11 of the navigation terminal apparatus 1a communicates with the GPS satellite 3 and always obtains the position information of the car and transmits to the central apparatus 2. The CPU 21 of the central apparatus 2 receives the position information from each of the navigation terminal apparatuses 1a, 1a - - - (the terminal apparatuses 1, 1 - - - ) and stores as the position information of the car in the RAM 23 at all times (Step S301).

Then, the calculation processor 11 of the navigation terminal apparatus 1a obtains the map update information indicating the change in the facility or road. The map update information includes: the information with regard to the tentative shop closure, for example, caused by the new establishment, razing, renewal or the like of a facility; and the information with regard to the new establishment or razing of a road, the tentative traffic stop caused by an enlargement or contraction of a road width, a construction, an accident and the like, the car lane reduction and the like. The map update information is not limited to them. If it is the information where the map information can be updated in schematically real time, it may be perfectly free.

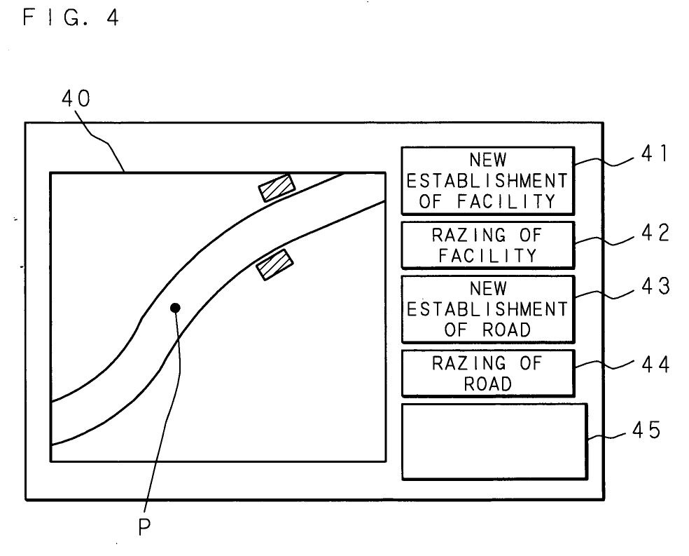

The map update information is obtained by receiving the input from the touch panel where the input unit 16 and the output unit 17 which are placed in the navigation terminal apparatus la are integrated into the single unit. FIG. 4 is the exemplification view of the displaying screen configuration of the navigation terminal apparatus 1a.

For example, in a case that a current position P of a car is displayed on a map information 40 displayed on the touch panel, and for example, a facility is newly established, when the user selects a [New Facility Establishment] button 41, the current position information of the car and the information indicating that a facility is newly established are sent to the central apparatus 2. Hereafter, in a case that a facility is razed, when the user selects a [Facility Razing] button 42, the current position information of the car and the information indicating that the facility is razed are sent to the central apparatus 2. In a case that a road is newly established, when the user selects a [New Road Establishment] button 43, the current position information of the car and the information indicating that the road is newly established are sent to the central apparatus 2. In a case that a road is razed, when the user selects a [Road Razing] button 44, the current position information of the car and the information indicating that the road is razed are sent to the central apparatus 2.

The CPU 21 of the central apparatus 2 receives the current position information and the change information with regard to the facility or road as mentioned above as the map update information from the navigation terminal apparatus 1a (Step S302) and judges whether or not the received map update information (change information) is the information related to the new establishment (Step S303). The method of judging whether or not the map update information is the information related to the new establishment is not especially limited. For example, it can be judged by storing a facility information table, in which the information related to the facilities are arranged for each address (city, ward, town or village), in the map information storing section 251 and then comparing with the received position information and map update information.

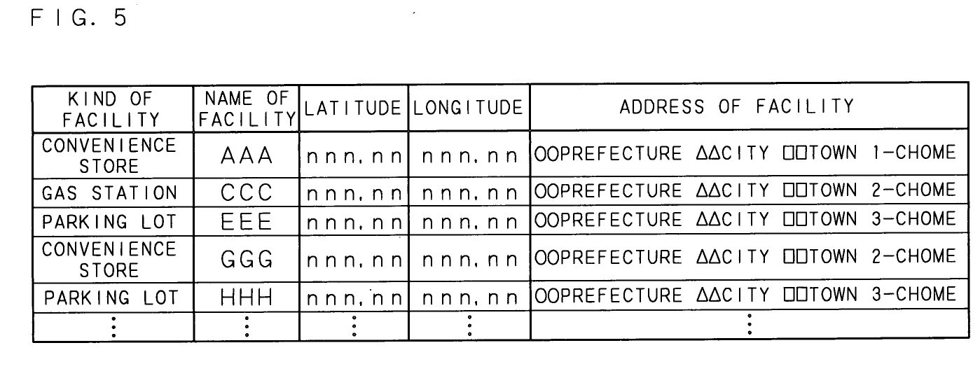

FIG. 5 is an exemplification view of the data configuration of the facility information table stored in the map information storing section 251. The facility information table stores a kind of a facility, a name, a latitude and a longitude, and an address specified in accordance with them. Thus, if the kind of the facility and the name which correspond to the received position information are not stored in the facility information table, it can be judged to be the information related to the new establishment.

If the CPU 21 judges that the received map update information is the information related to the new establishment (Step S303: YES), the CPU 21 sends an input request signal for requesting an input of the facility information such as a name of a newly established facility, a category of business and the like, to the navigation terminal apparatus 1a that is a transmission source of the position information and the new establishment information with regard to the facility or road as mentioned above (Step S304). The calculation processor 11 in the navigation terminal apparatus 1a receiving the input request signal receives the input of the facility information of the newly established facility through a touch pen or the like, from a predetermined region displayed on the touch panel, for example, an information input region 45 and sends to the central apparatus 2. The CPU 21 in the central apparatus 2 receives the facility information from the navigation terminal apparatus 1a (Step S305).

If the CPU 21 in the central apparatus 2 judges that the received map update information is not the information related to the new establishment (Step S303: NO), namely, if judging that the information related to the change or razing of the facility or road is received, or if receiving the facility information related to the newly established facility or road from the navigation terminal apparatus 1a receiving the new establishment information, the CPU 21 extracts the different terminal apparatuses 1, 1 - - - existing at the neighbor positions, in accordance with the received position information (Step S306). The method of extracting the different terminal apparatuses 1, 1 - - - existing at the neighbor positions is not especially limited. For example, the address (city, town, village or ward) is specified in accordance with the latitude and the longitude, and the different terminal apparatuses 1, 1 - - - in which the addresses are coincident are extracted.

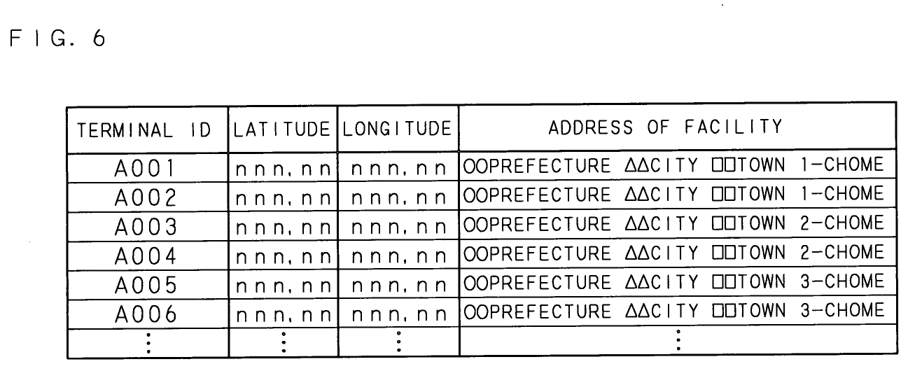

FIG. 6 is an exemplification view of the data configuration of the position information of the respective terminal apparatuses 1, 1 - - - stored in the map information storing unit 251. For example, a peculiar terminal ID is assigned to each of the navigation terminal apparatuses 1a, 1a - - - , and the latitude and longitude obtained by using the GPS receiver 15, and the current address specified in accordance with them are stored for each terminal ID. The CPU 21 in the central apparatus 2 extracts the terminal ID corresponding to the received position information.

The CPU 21 transmits a confirm request requirement to the different terminal apparatuses 1, 1 - - - corresponding to one or plurality of extracted terminals ID (Step S307). The confirm request requirement is the command to which the information indicating a reply of a confirm response together with the facility information and position information related to the facility or road is given.

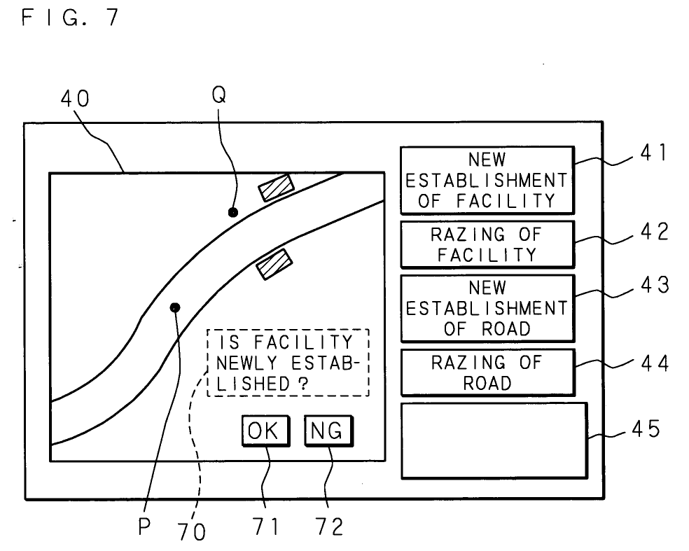

The different terminal apparatus 1 receiving the confirm request requirement, for example, the calculation processor 11 of the different navigation terminal apparatus 1a receives the confirm report of the user and transmits to the central apparatus 2. FIG. 7 is an exemplification view of the displaying screen configuration of the navigation terminal apparatus 1a.

When the confirm request requirement is received from the central apparatus 2, for example, the current position P of the car is added to the map information 40 displayed on the touch panel, and a position Q of a target facility (or road) of the confirm request requirement is displayed, and a confirm request message of [Has Facility Been Newly Established ?] is displayed on the screen. For example, if the actual fact of the new establishment of the facility is confirmed, when the user selects an [OK] button 71, the confirm report indicating that the fact of the new establishment of the facility is confirmed is transmitted to the central apparatus 2. On the other hand, if the actual fact of the newly establishment of the facility cannot be confirmed, when the user selects an [NG] button 72, a non-confirm report indicating that the fact of the new establishment of the facility cannot be confirmed is transmitted to the central apparatus 2.

The CPU 21 in the central apparatus 2 judges whether or not the confirm report is received (Step S308). If the CPU 21 judges that the confirm report is not received (Step S308: NO), the CPU 21 judges that the received facility information is an erroneous recognition (Step S308: NO), and ends the process. If the CPU 21 judges that the confirm report is received (Step S308: YES), the CPU 21 judges that the received facility information is the normal information and updates the map information (Step S309). Specifically, if the facility or road has been newly established, a new facility record is added to the facility information table stored in the map information storing section 251, and if the facility or road has been razed, the corresponding facility record is deleted from the facility information table stored in the map information storing section 251.

Of course, this is not limited to the method of directly adding to or deleting from the facility information table. This may be a method of collectively storing a facility record to be added as the map update information and a deletion record to be deleted, as an update table in the RAM 23 and collectively updating at a predetermined timing.

Also, the foregoing embodiment is explained with regard to the case that the map update information is received from the touch panel where the input unit 16 and output unit 17 that are installed in the navigation terminal apparatus 1a are integrated into the single unit. In this case, when the map update information is transmitted to the central apparatus 2, the map information stored in the central apparatus 2 is not instantly updated, and it is updated when the confirm reports of the different terminal apparatuses 1, 1 - - - are received. Thus, since the substantial real time is adequate, the received map update information may be stored in the RAM 13 of the terminal apparatus 1 and transmitted to the central apparatus 2 at a predetermined temporal interval. Such design can protect in advance the generation of the trouble that depending on the car position, the map update information cannot be transmitted to the central apparatus 2, without any necessity that the terminal apparatus 1 and the central apparatus 2 are always in the communicable states.

As mentioned above, according to this first embodiment, even in the case of the obtainment of the map update information related to the change in the facility or road, the map information is not immediately changed. Then, the confirm request as to whether or not there is the actual change is transmitted to the different terminal apparatuses 1, 1 - - - , and only if the change is confirmed, the map information is updated. Thus, it is possible to protect in advance the generation of the trouble that the map information stored in the central apparatus 2 is frequently updated on the basis of the erroneous map update information, and it is possible to update the map information in the substantially real time while maintaining the accuracy of the map information.

By the way, this first embodiment has been explained by exemplifying the case of using the navigation terminal apparatuses 1a, 1a - - - installed in the cars as the terminal apparatuses 1, 1 - - - . However, naturally, even the system where the portable telephones 1b, 1b - - - are used to transmit the confirm request requirement to a walker, so as to confirm the map update information of the facility or road provides the similar effect.

### SECOND EMBODIMENT

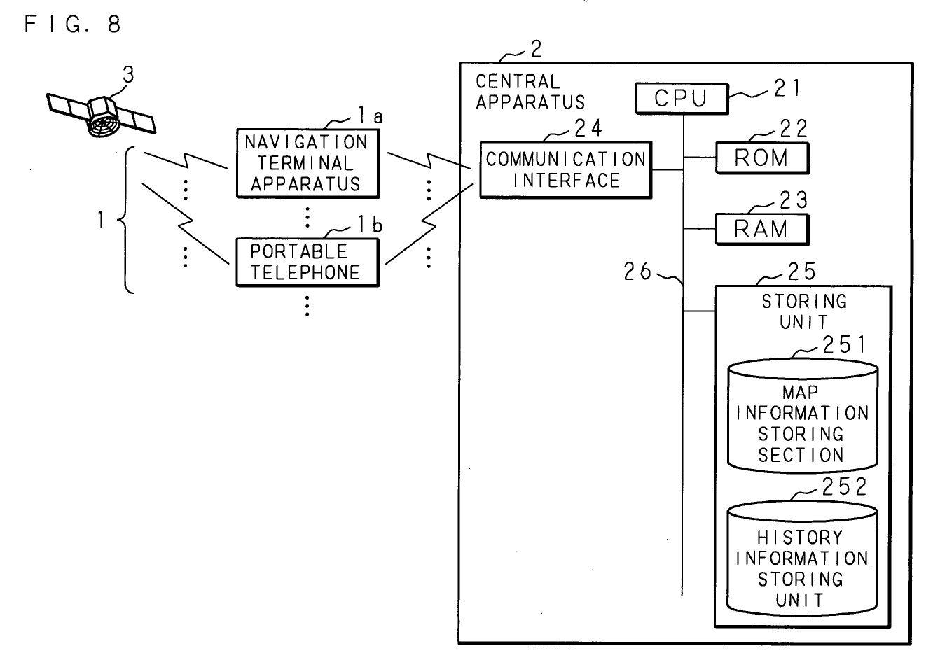

The present invention will be described below in detail on the basis of the drawing indicative of the second embodiment. FIG. 8 is a block diagram showing the configuration of the map information updating system according to the second embodiment of the present invention. The map information updating system according to this second embodiment is provided with: the terminal apparatuses 1, 1 - - - , such as the navigation terminal apparatuses 1a, 1a - - - installed in the cars, the portable telephones 1b, 1b . . . carried by the walkers and the like; and the central apparatus 2 that can wirelessly communicate with the terminal apparatuses 1, 1 - - - , similarly to the first embodiment. Also, the terminal apparatuses 1, 1 - - - can transmit or receive the signal to and from the GPS (Global Positioning System) satellite 3 and can obtain the latitude and the longitude as the position information. By the way, the terminal apparatus 1 is not limited to the navigation terminal apparatus 1a or the portable telephone 1b. If it is the mobile terminal apparatus, it is not especially limited.

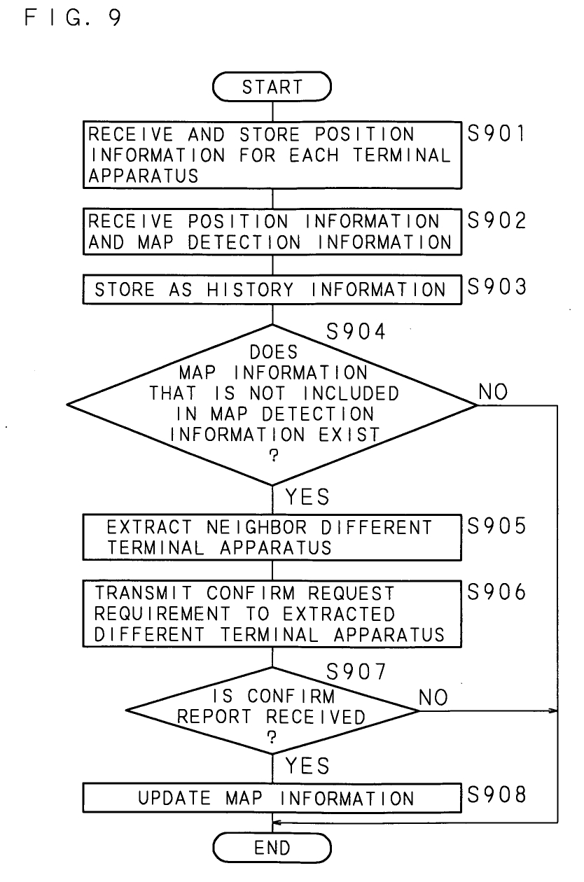

This second embodiment differs from the first embodiment in that the navigation terminal apparatus 1a obtains a map detection information indicating the detection of the existing facility or road and that a history information storing unit 252 for storing the map detection information and the position information received from the plurality of terminal apparatuses 1, 1 in time series is included in the storing unit 25 in the central apparatus 2. By the way, the configurations of the terminal apparatuses 1, 1 - - - are similr to the first embodiment. Hereafter, this is explained under assumption that the terminal apparatus 1 is the navigation terminal apparatus 1a in the car navigation system installed in the car. FIG. 9 is a flowchart showing the processing procedure of the CPU 21 in the central apparatus 2 of the map information updating system according to the second embodiment of the present invention.

While the user is driving the car, the calculation processor 11 in the navigation terminal apparatus 1a communicates with the GPS satellite 3 and always obtains the position information of the car and then transmits to the central apparatus 2. The CPU 21 in the central apparatus 2 receives the position information from each of the navigation terminal apparatuses 1a, 1a - - - (the terminal apparatuses 1, 1 - - - ) and stores as the position information of the car in the RAM 23 at all times (Step S901).

Then, the calculation processor 11 in the navigation terminal apparatus 1a obtains the map detection information indicating the detection of the facility or road. The map detection information includes, for example, the fact that there was previously the existing facility or road.

The obtainment of the map detection information is executed by the calculation processor 11 in the navigation terminal apparatus 1a. For example, by comparing the position information obtained from the GPS receiver 15 and the map information stored in the map information memory 18, the calculation processor 11 can judge that the car is moving on the existing road, namely, the existing road is detected. Also, when the navigation terminal apparatus 1a has an electronically payable apparatus such as ETC, an IC card or the like, by comparing the information indicating the position where the payment is executed and the stored map information, it is possible to judge that the existing facility is detected if the existing facility is judged to be used. The CPU 21 in the central apparatus 2 receives the current position information and the detection information with regard to the facility or road as mentioned above as the map detection information from the navigation terminal apparatus 1a (Step S902) and stores the received map detection information as a history information in the history information storing unit 252 (Step S903) and compares the already stored map detection information and the map information stored in the map information storing section 251 and then judges whether or not there is the facility or road of the map information which is not included in the map detection information (Step S904).

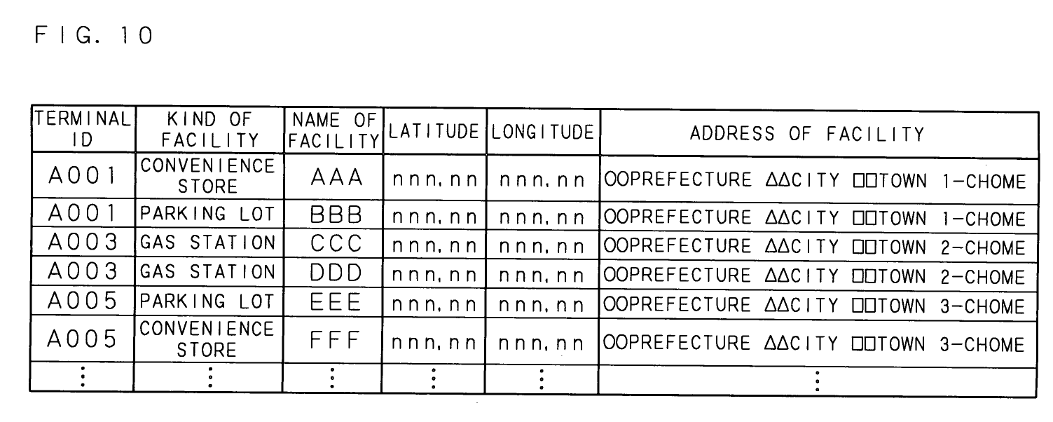

FIG. 10 is an exemplification view of the data configuration of the history information stored in the history information storing unit 252. In the history information, the kind of a facility, the name, the latitude and the longitude, and the address specified in accordance with them are stored while they are correlated to the terminal ID for identifying the terminal apparatus 1 which is the transmission source. Thus, for each terminal ID, it is possible to easily confirm the history as to which map update information is transmitted to the central apparatus 2.

If the CPU 21 judges that there is no facility or road of the map information which is not contained in the map detection information (Step S904: NO), the CPU 21 judges that the facility or road is not razed, and ends the process. If the CPU 21 judges that there is the facility or road of the map information which is not contained in the map detection information (Step S904: YES), the CPU 21 extracts the different terminal apparatuses 1, 1 - - - existing at the neighbor positions, in accordance with the position information of the facility or road of the map information which is not contained in the map detection information (Step S905). The method of extracting the different terminal apparatuses 1, 1 - - - existing at the neighbor positions is not especially limited. For example, the address (city, town, village or ward) is specified in accordance with the latitude and the longitude, and the different terminal apparatuses 1, 1 - - - in which the addresses are coincident are extracted.

The CPU 21 transmits the confirm request requirement to one or plurality of extracted terminal apparatuses 1, 1 - - - (Step S906). The confirm request requirement is the command to which the information indicating the reply of the confirm response together with the facility information and position information related to the facility or road is given. The different terminal apparatus 1 receiving the confirm request requirement, for example, the calculation processor 11 in the different navigation terminal apparatus 1a receives the confirm report of the user and transmits to the central apparatus 2.

The CPU 21 in the central apparatus 2 judges whether or not the confirm report is received (Step S907). If the CPU 21 judges that the confirm report is not received (Step S907: NO), the CPU 21 judges that the judgment where the facility or road is razed is mistaken, and ends the process. If the CPU 21 judges that the confirm report is received (Step S907: YES), the CPU 21 judges that the received facility information is the normal information, and updates the map information (Step S908). Specifically, this deletes the corresponding facility record from the facility information table stored in the map information storing section 251.

Of course, this is not limited to the method of directly deleting from the facility information table. This may be the method of collectively storing the facility record to be deleted as the update table in the RAM 23 and collectively updating at the predetermined timing.

Also, the foregoing embodiment is explained with regard to the case that the map update information is received from the touch panel where the input unit 16 and output unit 17 that are installed in the navigation terminal apparatus 1a are integrated into the single unit. In this case, when the map detection information is transmitted to the central apparatus 2, the map information stored in the central apparatus 2 is not instantly updated, and it is updated when the confirm reports of the different terminal apparatuses 1, 1 - - - are received. Thus, since the substantial real time update is adequate, the received map detection information may be stored in the RAM 13 of the terminal apparatus 1 and transmitted to the central apparatus 2 at the predetermined temporal interval. Such design can protect in advance the generation of the trouble that depending on the car position, the map detection information cannot be transmitted to the central apparatus 2, without any necessity that the terminal apparatus 1 and the central apparatus 2 are always in the communicable states.

As mentioned above, according to this second embodiment, the fact that the facility or road located at the predetermined position is razed is detected from the fact that it is not contained in the map detection information, and the map information is not immediately updated. Then, the confirm request as to the whether or not they are actually razed is transmitted to a different terminal apparatus. Thus, before the map information is discarded, the information as to whether or not it is really changed can be obtained from the different terminal apparatus. Hence, it is possible to protect in advance the generation of the trouble that the map information stored in the central apparatus is frequently updated on the basis of the erroneous map update information, and it is possible to update the map information in the substantially real time while maintaining the accuracy of the map information.

By the way, this second embodiment has been explained by exemplifying the case of using the navigation terminal apparatuses 1a, 1a - - - installed in the cars as the terminal apparatuses 1, 1 - - - . However, naturally, even the system where the portable telephones 1b, 1b - - - are used to transmit the confirm request requirement to the walker, so as to confirm the map detection information provides the similar effect.

### THIRD EMBODIMENT

The present invention will be described below in detail on the basis of the drawing showing the third embodiment. The configuration of the map information updating system according to the third embodiment of the present invention is similar to that of the first embodiment. Thus, the same symbols are given, and the detailed explanation is omitted. The map information updating system according to this third embodiment differs from the first embodiment in that a picture imaging unit 20 for imaging a peripheral picture is included by each of the navigation terminal apparatuses 1a, 1a - - - installed in the cars and the change in the peripheral facility or road is detected in accordance with the difference of the picture imaged by the picture imaging unit 20.

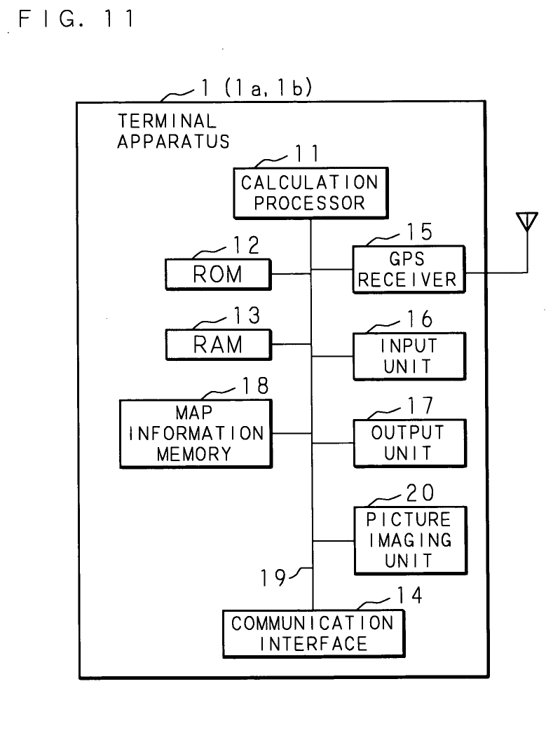

FIG. 11 is a block diagram showing the configuration of the terminal apparatus 1 in the map information updating system according to the third embodiment of the present invention. The terminal apparatus 1 includes at least the calculation processor 11 such as MPU, DSP or the like, the ROM 12, the RAM 13, the communication interface 14 that can carry out the radio communication, the GPS receiver 15, the input unit 16, the output unit 17, the map information memory 18 and the picture imaging unit 20.

The calculation processor 11 is connected through the inner bus 19 to the respective units of the hardware of the terminal apparatus 1 and controls the respective units of the hardware and also executes the various software functions, in accordance with: the processing program stored in the ROM 12; the program for receiving or detecting the update information of, for example, the facility or road located in the periphery; the program for transmitting the update information of the received or detected facility or road to the central apparatus 2; the program for receiving the confirm request of the update information of the facility or road from the central apparatus 2; the program for transmitting the confirm report corresponding to the confirm request; a program for detecting the change in the facility or road in accordance with the imaged picture; and the like.

The picture imaging unit 20 has an imaging element for converting an optical signal into an electric signal and transmits an output brightness signal of the imaging element to the calculation processor 11. The calcuation processor 11 converts the brightness signal received from the picture imaging unit 20 into a digital signal and performs a compensating process thereon. Then, it is converted into a YUV (Y: brightness signal, U, V: color difference) signal and the like, and stored as a picture data in the RAM 13.

The picture imaging unit 20 is placed at the top end of the navigation terminal apparatus 1a so as to be able to image the periphery through a front window. Of course, this is not always required to be built in the navigation terminal apparatus 1a. For example, only the imaging unit may be placed in a door mirror or the like, and the imaged picture may be transferred through a communication line to the calculation processor 11 in the navigation terminal apparatus 1a.

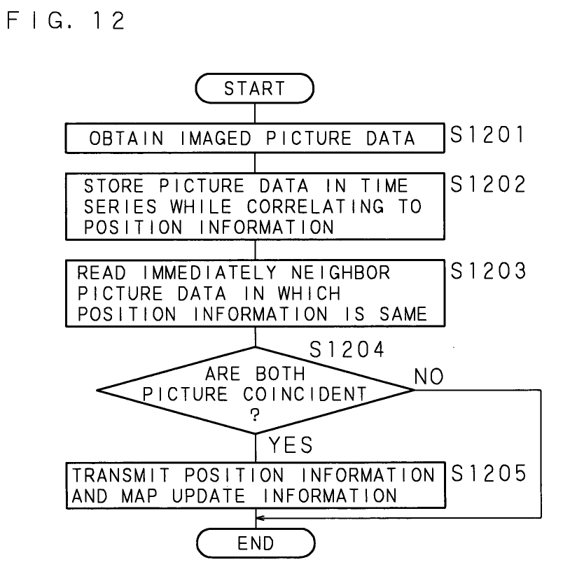

FIG. 12 is a flowchart showing the processing procedure of the calcuation processor 11 in the terminal apparatus 1 in the map information updating system according to the third embodiment of the present invention. The calculation processor 11 obtains a picture data from the picture imaging unit 20 (Step S1201) and correlates to the position information of the car and stores in the RAM 13 in time series with the storing unit 25 (Step S1202).

The calculation processor 11, when obtaining the picture data from the picture imaging unit 20, inquires the RAM 13 and reads the picture data having the same position information which are temporally immediate (Step S1203). The calculation processor 11 compares the picture data obtained from the picture imaging unit 20 and the picture data read from the RAM 13 and judges whether or not both of the pictures are coincident (Step S1204).

The method of judging whether or not the picture data obtained from the picture imaging unit 20 and the picture data read from the RAM 13 are coincident is not especially limited. For example the installation position of the imaging unit is fixed to a predetermined position of the car, and if the relative value between the pictures in the same latitude and longitude is smaller than a predetermined value, both of the pictures are judged to be coincident. Also, a method in which a predetermined picture within a picture, for example, a sign-board of a facility or the like is extracted by an edge detecting process and the like, and if characters recognized by a character recognition are coincident, both of the picture are judged to be coincident is allowable.

If the calculation processor 11 judges that both of the pictures are coincident (Step S1204: YES), the calculation processor 11 judges that the facility or road is not changed, and ends the process. If the calculation processor 11 judges that both of the pictures are not coincident (Step S1204: NO), the calculation processor 11 judges that the facility or road is changed, and transmits the current position information and the change information with regard to the facility or road as the map update information to the central apparatus 2 (Step S1205). The central apparatus 2 receiving the current position information and the change information with regard to the facility or road as the map update information executes the processes similar to those of the first and second embodiments and updates the map information.

As mentioned above, according to this third embodiment, the fact that the facility or road located at the predetermined position is newly established or razed is detected from the fact that the picture data corresponding to the same position information are not coincident. Then, the map update information can be transmitted to the central apparatus 2 without any awareness of the user. Thus, for example, in the case of using the navigation terminal apparatus installed in the car, it is possible to detect the new facility or road without any operation of a driver or detect the fact that the facility or road is razed. Also, it is possible to update the map information in the schematically real time without any demand of the complex operation on the user.

By the way, in this third embodiment, the example is explained in which the navigation terminal apparatuses 1a, 1a - - - included in the cars are used as the terminal apparatuses 1, 1 - - - . However, even in the case that the portable telephones 1b, 1b - - - are used and the imaging units installed in the portable telephones 1b, 1b - - - are used to then detect the change in the facility or road, the similar effect is naturally provided.

### FOURTH EMBODIMENT

The present invention will be described below in detail on the basis of the drawing showing the fourth embodiment. Since the configuration of the map information updating system according to the fourth embodiment of the present invention is similar to that of the first embodiment, the same symbols are given, and the detailed explanation is omitted. The map information updating system according to this fourth embodiment differs from the first embodiment in that the position information of the navigation terminal apparatuses 1a, 1a - - - installed in the cars are stored in the time series, and the movement vectors of the navigation terminal apparatuses 1a; 1a - - - are calculated, and the confirm request requirement is consequently transmitted to the different terminal apparatuses 1, 1 - - - which are going towards the positions of the facility or road related to the map update information.

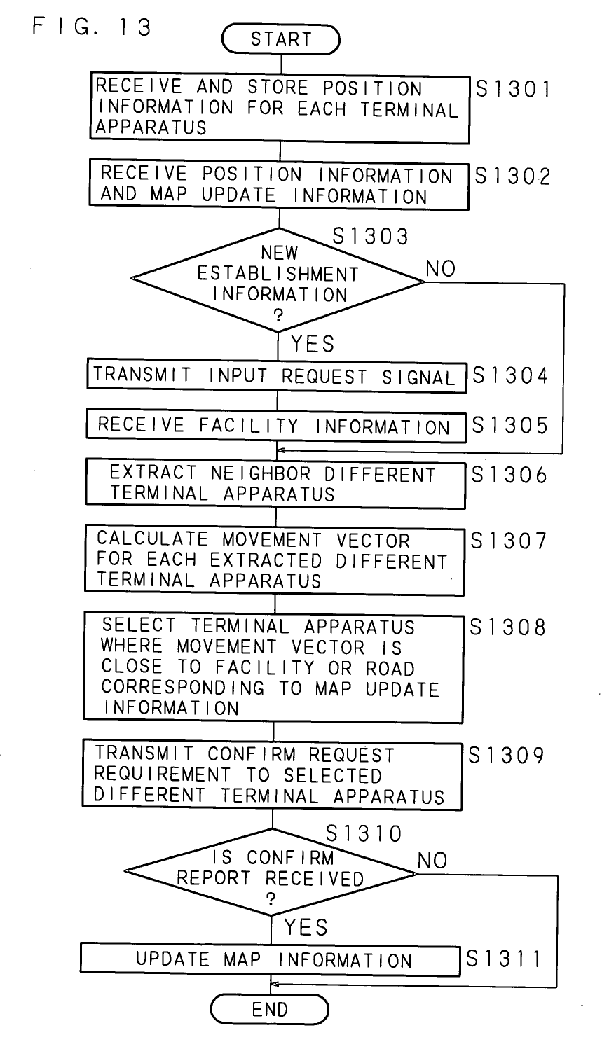

FIG. 13 is a flowchart showing the processing procedure of the CPU 21 in the central apparatus 2 in the map information updating system according to the fourth embodiment of the present invention. While the user is driving the car, the calculation processor 11 in the navigation terminal apparatus 1a communicates with the GPS satellite 3, and consequently always obtains the position information of the car and then transmits to the central apparatus 2. The CPU 21 in the central apparatus 2 receives the position information from each of the navigation terminal apparatuses 1a, 1a - - - (the terminal apparatuses 1, 1 - - -) and stores as the position information of the car in the RAM 23 at all times (Step S1301).

Then, the calculation processor 11 in the navigation terminal apparatus 1a obtains the map update information indicating that the facility or road is changed. The CPU 21 in the central apparatus 2 receives the current position information and the change information with regard to the facility or road as mentioned above, as the map update information, from the navigation terminal apparatus 1a (Step S1302) and judges whether or not the received map update information (change information) is the information related to the new establishment (Step S1303).

If the CPU 21 judges that the received map update information is the information related to the new establishment (Step S1303: YES), the CPU 21 transmits the position information and an input request signal for requesting the navigation terminal apparatus 1a, which is the transmission source of the new establishment information with regard to the facility or road as mentioned above, to input the facility information such as the name of the newly established facility, the category of business and the like (Step S1304). The calculation processor 11 in the navigation terminal apparatus 1a, which receives the input request signal, receives the input of the facility information of the newly established facility through the touch pen or the like, from a predetermined region displayed on the touch panel, and transmits to the central apparatus 2. The CPU 21 in the central apparatus 2 receives the facility information from the navigation terminal apparatus 1a (Step S1305).

If the CPU 21 in the central apparatus 2 judges that the received map update information is not the information related to the new establishment (Step S1303: NO), namely, judges that the information related to the change or razing of the facility or road is received, or receives the information related to the newly established facility or road from the navigation terminal apparatus 1a receiving the new establishment information, the CPU 21 extracts the different terminal apparatuses 1, 1 - - - existing at the neighbor positions, in accordance with the received position information (Step S1306). The method of extracting the different terminal apparatuses 1, 1 - - - existing at the neighbor positions is not limited. For example, the address (city, town, village or ward) is specified in accordance with the latitude and the longitude. Consequently, the different terminal apparatuses 1, 1 - - - in which the addresses are coincident are extracted.

The CPU 21 in the central apparatus 2 calculates the movement vector for each of the extracted different terminal apparatuses 1, 1 - - - (Step S1307) and selects the different terminal apparatuses 1, 1 - - - where the position of the facility or road corresponding to the received map update information is close to the movement vector (Step S1308). The movement vector is calculated in accordance with the position information stored in time series for each terminal apparatus 1. Then, whether or not it is selected as the terminal apparatus 1 that transmits the confirm request requirement is judged depending on whether or not the position of the facility or road corresponding to the map update information exists on the schematic extension line of the movement vector with the current position for each terminal apparatus 1 as a start point. By the way, the calculating method of the movement vector is not limited to this, and the selecting method of the terminal apparatuses 1, 1 - - - is not also limited to this.

The CPU 21 transmits the confirm request requirement to the different terminal apparatuses 1, 1 - - - corresponding to one or a plurality of selected terminals It) (Step S1309). The confirm request requirement is the command to which the information indicating the reply of the confirm response together with the facility information and position information related to the facility or road is given.

The CPU 21 in the central apparatus 2 judges whether or not the confirm report is received (Step S1310). If the CPU 21 judges that the confirm report is not received (Step S1310: NO), the CPU 21 judges that the received facility information is the erroneous recognition, and ends the process. If the CPU 21 judges that the confirm report is received (Step S1310: YES), the CPU 21 judges that the received facility information is the normal information and updates the map information (Step S1311). Specifically, if the facility or road has been newly established, the new facility record is added to the facility information table stored in the map information storing section 251, and if the facility or road has been razed, the corresponding facility record is deleted from the facility information table stored in the map information storing section 251.

As mentioned above, according to this fourth embodiment, the fact that the facility or road located at the predetermined position is newly established or razed is confirmed for the different terminal apparatus 1 which is going towards the position of the newly established or razed facility or road. Thus, the user receiving the confirm request requirement can confirm whether or not the facility or road is newly established or razed without any resistance. Hence, whether or not the map update information is normal can be confirmed without any load on the user.

By the way, this fourth embodiment has been explained by exemplifying the case of using the navigation terminal apparatuses 1a, 1a - - - installed in the cars as the terminal apparatuses 1, 1 - - - . However, even in a case where the portable telephones 1b, 1b - - - are used to calculate the traveling directions of the users carrying the portable telephones 1b, 1b - - - as the movement vectors, the similar effect is naturally provided.

### FIFTH EMBODIMENT

The present invention will be described below in detail on the basis of the drawing showing the fifth embodiment. Since the configuration of the map information updating system according to the fifth embodiment of the present invention is similar to that of the first embodiment, the same symbols are given, and the detailed explanation is omitted. The map information updating system according to this fifth embodiment differs from the first embodiment in that the navigation terminal apparatuses 1a, 1a - - - installed in the cars store the position information of the movement schedules and transmit the confirm request requirement to the different terminal apparatuses 1, 1 - - - where the facility or road related to the map update information exists on the course of the route information.

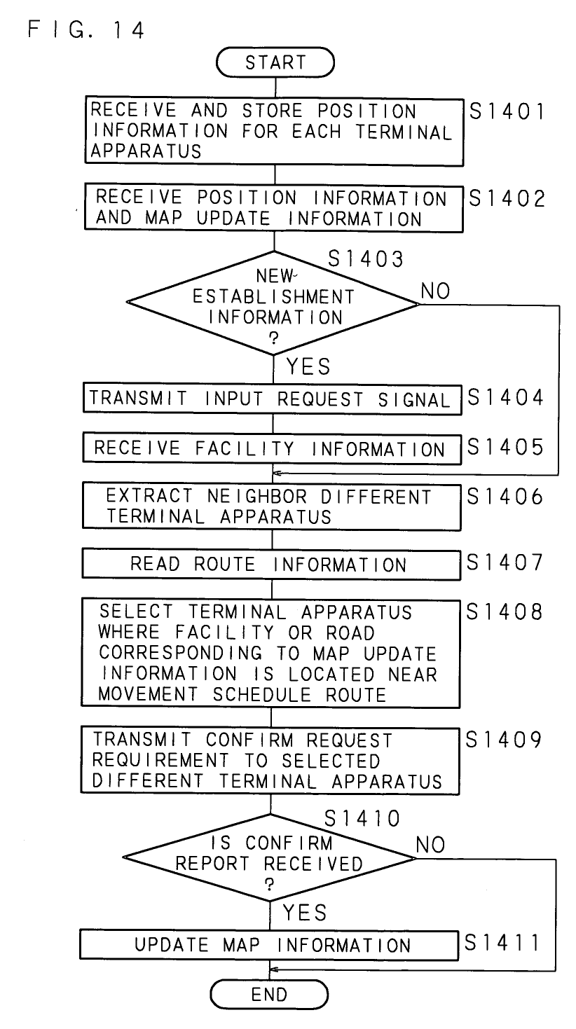

FIG. 14 is a flowchart showing the processing procedure of the CPU 21 in the central apparatus 2 in the map information updating system according to the fifth embodiment of the present invention. While the user is driving the car, the calculation processor 11 in the navigation terminal apparatus 1a communicates with the GPS satellite 3, and consequently always obtains the position information of the car and then transmits to the central apparatus 2. The CPU 21 in the central apparatus 2 receives the position information from each of the navigation terminal apparatuses 1a, 1a - - - (the terminal apparatuses 1, 1 - - -) and stores as the position information of the car in the RAM 23 at all times (Step S1401).

Then, the calculation processor 11 in the navigation terminal apparatus 1a obtains the map update information indicating that the facility or road is changed. The CPU 21 in the central apparatus 2 receives the current position information and the change information with regard to the facility or road as mentioned above, as the map update information, from the navigation terminal apparatus 1a (Step S1402) and judges whether or not the received map update information (change information) is the information related to the new establishment (Step S1403).

If the CPU 21 judges that the received map update information is the information related to the new establishment (Step S1403: YES), the CPU 21 transmits the position information and the input request signal for requesting the navigation terminal apparatus 1a, which is the transmission source of the information related to the new establishment with regard to the facility or road as mentioned above, to input the facility information such as the name of the newly established facility, the category of business and the like (Step S1404). The calculation processor 11 in the navigation terminal apparatus 1a, which receives the input request signal, receives the input of the facility information of the newly established facility through the touch pen or the like, from the predetermined region displayed on the touch panel, and transmits to the central apparatus 2. The CPU 21 in the central apparatus 2 receives the facility information from the navigation terminal apparatus 1a (Step S1405).

If the CPU 21 in the central apparatus 2 judges that the received map update information is not the information related to the new establishment (Step S1403: NO), namely, judges that the information related to the change or razing of the facility or road is received, or receives the facility information related to the newly established facility or road from the navigation terminal apparatus 1a receiving the information related to the new establishment, the CPU 21 extracts the different terminal apparatuses 1, 1 - - - existing at the neighbor positions, in accordance with the received position information (Step S1406). The method of extracting the different terminal apparatuses 1, 1 - - - existing at the neighbor positions is not limited. For example, the address (city, town, village or ward) is specified in accordance with the latitude and the longitude. Consequently, the different terminal apparatuses 1, 1 - - - in which the addresses are coincident are extracted.

The CPU 21 in the central apparatus 2 reads the route information stored for each of the extracted different terminal apparatuses 1, 1 - - - (Step S1407) and selects the different terminal apparatuses 1, 1 - - - where the position of the facility or road corresponding to the received map update information is closed to the course of the movement schedule route (Step S1408). In the route information, the movement schedule route is specified for each terminal apparatus 1, and the latitude and longitude of the movement schedule route are stored in the RAM 13. Thus, if the position of the facility or road corresponding to the received map update information exists on the movement schedule route or at the neighbor position, whether or not the map update information is normal can be surely confirmed. Hence, whether or not it is selected as the terminal apparatus 1 that transmits the confirm request requirement is judged depending on whether or not the facility or road corresponding to the map update information exists on the movement schedule route or at the neighbor position. By the way, the specifying method of the movement schedule route is not especially limited. Also, the selecting method of the terminal apparatuses 1, 1 - - - is not limited.

The CPU 21 transmits the confirm request requirement to the different terminal apparatuses 1, 1 - - - corresponding to one or a plurality of selected terminals ID (Step S1409). The confirm request requirement is the command to which the information indicating the reply of the confirm response together with the facility information and position information related to the facility or road is given.

The CPU 21 in the central apparatus 2 judges whether or not the confirm report is received (Step S1410). If the CPU 21 judges that the confirm report is not received (Step S1410: NO), the CPU 21 judges that the received facility information is the erroneous recognition, and ends the process. If the CPU 21 judges that the confirm report is received (Step S1410: YES), the CPU 21 judges that the received facility information is the normal information and updates the map information (Step S1411). Specifically, if the facility or road has been newly established, the new facility record is added to the facility information table stored in the map information storing section 251, and if the facility or road has been razed, the corresponding facility record is deleted from the facility information table stored in the map information storing section 251.

As mentioned above, according to this fifth embodiment, the fact that the facility or road located at the predetermined position is newly established or razed is confirmed for the different terminal apparatus 1 where the newly established or razed facility or road exists on the movement schedule route. Thus, the user receiving the confirm request requirement can confirm whether or not the facility or road is newly established or razed without any resistance. Hence, whether or not the map update information is normal can be confirmed without any load on the user.

By the way, this fifth embodiment has been explained by exemplifying the case of using the navigation terminal apparatuses 1a, 1a - - - installed in the cars as the terminal apparatuses 1, 1 - - - . However, even in a case of selecting the terminal apparatuses 1, 1 - - - to be confirmed by using the portable telephones 1b, 1b - - - and then using the movement schedule routes of the users carrying the portable telephones 1b, 1b - - -, the similar effect is naturally provided.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A map information updating system which includes: a plurality of terminal apparatuses for obtaining a map update information related to a change in a facility or road; and a central apparatus for obtaining said map update information from the plurality of terminal apparatuses and updating a stored map information,
wherein each terminal apparatus comprises:
means for obtaining a position information with regard to an existence position;
means for transmitting the obtained position information to said central apparatus;
obtaining means for obtaining said map update information; and
means for transmitting the obtained map update information to said central apparatus, and
the central apparatus comprises:
means for receiving said position information and map update information;
means for comparing the received position information and map update information and the stored map information and judging whether or not there is any difference from the map information;
means for transmitting a confirm request as to whether or not the map update information is normal, to a different terminal apparatus located within a predetermined range with respect to a position of a terminal apparatus that is a transmission source of said position information and map update information, in case for judging that there is any difference; and
means for updating the stored map information, in case for receiving a confirm report indicative of the normality for said confirm request from said different terminal apparatus.

2. A map information updating system which includes: a plurality of terminal apparatuses for obtaining a map detection information related to a detection of an existing facility or road; and a central apparatus for obtaining said map detection information from the plurality of terminal apparatuses and updating a stored map information,
wherein each terminal apparatus comprises:
means for obtaining a position information with regard to a position at which the terminal apparatus exists;
means for transmitting the obtained position information to said central apparatus;
obtaining means for obtaining said map detection information; and
means for transmitting the obtained map detection information to said central apparatus, and
the central apparatus comprises:
means for receiving said position information and map detection information;
history information storing means for storing the received position information and map detection information in time series;
means for comparing the stored position information and map detection information and the stored map information and judging whether or not there is any difference from the map information;
means for transmitting a confirm request as to whether or not the map detection information is normal, to a different terminal apparatus located within a predetermined range with respect to a position of a facility or road of the stored map information, in case for judging that there is any difference; and
means for updating the stored map information, in case for receiving a confirm report indicative of the normality for said confirm request from said different terminal apparatus.

3. The map information updating system according to claim 1,
wherein the terminal apparatus further comprises:
means for storing the map update information obtained by said obtaining means in storing means; and
means for transmitting the stored map update information to said central apparatus at a predetermined temporal interval.

4. The map information updating system according to claim 1,
wherein the terminal apparatus further comprises:
a picture imaging unit for imaging a peripheral picture; and
a detecting unit for detecting a change in a facility or road in accordance with the imaged picture, and
the detecting unit comprises:
means for storing a picture in time series while correlating to the position information;
means for judging whether or not an immediately stored picture and an obtained picture are coincident; and
means for transmitting the obtained picture and position information to the central apparatus, in case for judging that they are not coincident.

5. The map information updating system according to claim 2,
wherein the terminal apparatus further comprises:
means for storing the map detection information obtained by said obtaining means in storing means; and
means for transmitting the stored map detection information to said central apparatus at a predetermined temporal interval.

6. The map information updating system according to claim 2,
wherein the terminal apparatus further comprises:
a picture imaging unit for imaging a peripheral picture; and
a detecting unit for detecting a change in a facility or road in accordance with the imaged picture, and
the detecting unit comprises:
means for storing a picture in time series while correlating to the position information;
means for judging whether or not an immediately stored picture and an obtained picture are coincident; and
means for transmitting the obtained picture and position information to the central apparatus, in case for judging that they are not coincident.

7. A map information updating system which includes: a plurality of terminal apparatuses for obtaining a map update information related to a change in a facility or road; and a central apparatus for obtaining said map update information from the plurality of terminal apparatuses and updating a stored map information,
wherein each terminal apparatus comprise a processor capable for performing the steps of:
obtaining a position information with regard to a position at which each terminal apparatus exists;
transmitting the obtained position information to said central apparatus;
obtaining said map update information; and
transmitting the obtained map update information to said central apparatus, and
the central apparatus comprises a processor capable for performing the steps of:
receiving said position information and map update information;
comparing the received position information and map update information and the stored map information and judging whether or not there is any difference from the map information;
in case for judging that there is any difference, transmitting a confirm request as to whether or not the map update information is normal, to a different terminal apparatus located within a predetermined range with respect to a position of a terminal apparatus that is a transmission source of said position information and map update information; and
in case for receiving a confirm report indicative of the normality for said confirm request from said different terminal apparatus, updating the stored map information.

8. A map information updating system which includes: a plurality of terminal apparatuses for obtaining a map detection information related to a detection of an existing facility or road; and a central apparatus for obtaining said map detection information from the plurality of terminal apparatuses and updating a stored map information,
wherein each terminal apparatus comprises a processor capable for performing the steps of:
obtaining a position information with regard to a position at which the terminal apparatus exists;
transmitting the obtained position information to said central apparatus;
obtaining said map detection information; and
transmitting the obtained map detection information to said central apparatus, and
the central apparatus comprises a processor capable for performing the steps of:
receiving said position information and map detection information;
storing the received position information and map detection information in time series;
comparing the stored position information and map detection information and the stored map information and judging whether or not there is any difference from the map information;
in case for judging that there is any difference, transmitting a confirm request as to whether or not the map detection information is normal, to a different terminal apparatus located within a predetermined range with respect to a position of a facility or road of the stored map information; and
in case for receiving a confirm report indicative of the normality for said confirm request from said different terminal apparatus, updating the stored map information.

9. The map information updating system according to claim 7, wherein the terminal apparatus comprises the processor further capable for performing the steps of:
storing the obtained map update information in storing means; and
transmitting the stored map update information to said central apparatus at a predetermined temporal interval.

10. The map information updating system according to claim 7,
wherein the terminal apparatus further comprises:
a picture imaging unit for imaging a peripheral picture; and
a detecting unit for detecting a change in a facility or road in accordance with the imaged picture, and
the detecting unit comprises the processor further capable for performing the steps of:
storing a picture in time series while correlating to the position information;
judging whether or not an immediately stored picture and an obtained picture are coincident; and
if judging that they are not coincident, transmitting the obtained picture and position information to the central apparatus.

11. The map information updating system according to claim 8, wherein the terminal apparatus comprises the processor further capable for performing the steps of:
storing the obtained map detection information in storing means; and
transmitting the stored map detection information to said central apparatus at a predetermined temporal interval.

12. The map information updating system according to claim 8,
wherein the terminal apparatus further comprises:
a picture imaging unit for imaging a peripheral picture; and
a detecting unit for detecting a change in a facility or road in accordance with the imaged picture, and
the detecting unit comprises the processor further capable for performing the steps of:
storing a picture in time series while correlating to the position information;
judging whether or not an immediately stored picture and an obtained picture are coincident; and
if judging that they are not coincident, transmitting the obtained picture and position information to the central apparatus.

13. A central apparatus which obtains, from a plurality of terminal apparatuses for obtaining a map update information related to a change in a facility or road, said map update information, and updates a stored map information, and comprises:
means for receiving position information with regard to positions at which said plurality of terminal apparatuses exist and said map update information;
means for comparing the received position information and map update information and the stored map information and judging whether or not there is any difference from the map information;
means for transmitting a confirm request as to whether or not the map update information is normal, to a different terminal apparatus located within a predetermined range with respect to a position of a terminal apparatus that is a transmission source of said position information and map update information, in case for judging that there is any difference; and
means for updating the stored map information, in case for receiving a confirm report indicative of the normality for said confirm request from said different terminal apparatus.

14. A central apparatus which obtains, from a plurality of terminal apparatuses for obtaining a map detection information related to a detection of an existing facility or road, said map detection information, and updates a stored map information, and comprises:
means for receiving position information with regard to positions at which said plurality of terminal apparatuses exist and said map detection information;
history information storing means for storing the received position information and map detection information in time series;
means for comparing the stored position information and map detection information and the stored map information and judging whether or not there is any difference from the map information;
means for transmitting a confirm request as to whether or not the map detection information is normal, to a different terminal apparatus located within a predetermined range with respect to a position of a facility or road of the stored map information, in case for judging that there is any difference; and
means for updating the stored map information, in case for receiving a confirm report indicative of the normality for said confirm request from said different terminal apparatus.

15. A central apparatus which obtains, from a plurality of terminal apparatuses for obtaining a map update information related to a change in a facility or road, said map update information, and updates a stored map information, and comprises a processor capable for performing the steps of:
receiving position information with regard to positions at which said plurality of terminal apparatuses exist and said map update information;
comparing the received position information and map update information and the stored map information and judging whether or not there is any difference from the map information;
in case for judging that there is any difference, transmitting a confirm request as to whether or not the map update information is normal, to a different terminal apparatus located within a predetermined range with respect to a position of a terminal apparatus that is a transmission source of said position information and map update information; and
updating the stored map information, in case for receiving a confirm report indicative of the normality for said confirm request from said different terminal apparatus.

16. A central apparatus which obtains, from a plurality of terminal apparatuses for obtaining a map detection information related to a detection of an existing facility or road, said map detection information and updates a stored map information, and comprises a processor capable for performing the steps of:
receiving position information with regard to positions at which said plurality of terminal apparatuses exist and said map detection information;
storing the received position information and map detection information in time series;
comparing the stored position information and map detection information and the stored map information and judging whether or not there is any difference from the map information;
in case for judging that there is any difference, transmitting a confirm request as to whether or not the map detection information is normal, to a different terminal apparatus located within a predetermined range with respect to a position of a facility or road of the stored map information; and
updating the stored map information, in case for receiving a confirm report indicative of the normality for said confirm request from said different terminal apparatus.

17. A map information updating method using: a plurality of terminal apparatuses for obtaining a map update information related to a change in a facility or road; and a central apparatus for obtaining said map update information from the plurality of terminal apparatuses and updating a stored map information,
wherein each terminal apparatus comprise the steps of:
obtaining a position information with regard to a position at which each terminal apparatus exists;
transmitting the obtained position information to said central apparatus;
obtaining said map update information; and
transmitting the obtained map update information to said central apparatus, and
the central apparatus comprises the steps of:
receiving said position information and map update information;
comparing the received position information and map update information and the stored map information and judging whether or not there is any difference from the map information;
in case for judging that there is any difference, transmitting a confirm request as to whether or not the map update information is normal, to a different terminal apparatus located within a predetermined range with respect to a position of a terminal apparatus that is a transmission source of said position information and map update information; and
updating the stored map information, in case for receiving a confirm report indicative of the normality for said confirm request from said different terminal apparatus.

18. A map information updating method using: a plurality of terminal apparatuses for obtaining a map detection information related to a detection of an existing facility or road; and a central apparatus for obtaining said map detection information from the plurality of terminal apparatuses and updating a stored map information,
wherein each terminal apparatus comprises the steps of:
obtaining a position information with regard to a position at which the terminal apparatus exists;
transmitting the obtained position information to said central apparatus;
obtaining said map detection information; and
transmitting the obtained map detection information to said central apparatus, and
the central apparatus comprises the steps of:
receiving said position information and map detection information;
storing the received position information and map detection information in time series;
comparing the stored position information and map detection information and the stored map information and judging whether or not there is any difference from the map information;
in case for judging that there is any difference, transmitting a confirm request as to whether or not the map detection information is normal, to a different terminal apparatus located within a predetermined range with respect to a position of a facility or road of the stored map information; and
updating the stored map information, in case for receiving a confirm report indicative of the normality for said confirm request from said different terminal apparatus.

19. A recording medium for storing a computer program for a computer, which obtains a map update information related to a change in a facility or road from an outside and updates a stored map information,
wherein the computer program stored in the recording medium comprises the steps of:
causing the computer to receive a position information with regard to a position and said map update information from the outside;
causing the computer to compare the received position information and map update information and the stored map information and judge whether or not there is any difference from the map information;
causing the computer to transmit a confirm request as to whether or not the map update information is normal, to a different transmission destination located within a predetermined range with respect to a position of a transmission source of said position information and map update information, if judging them to be different, and
causing the computer to update the stored map information, when receiving a confirm report indicative of the normality for said confirm request from said different transmission destination.

20. A recording medium for storing a computer program for a computer, which obtains, from a plurality of terminal apparatuses for obtaining a map detection information related to a detection of an existing facility or road, said map detection information, and updates a stored map information,
wherein the computer program stored in the recording medium comprises the steps of:
causing the computer to receive position information with regard to positions at which said plurality of terminal apparatuses exist and said map detection information;
causing the computer to store the received position information and map detection information in time series;
causing the computer to compare the stored position information and map detection information and the stored map information and judge whether or not there is any difference from the map information;
causing the computer to transmit a confirm request as to whether or not the map detection information is normal, to a different terminal apparatus located within a predetermined range with respect to a position of a facility or road of the stored map information, if judging them to be different, and
causing the computer to update the stored map information, when receiving a confirm report indicative of the normality for said confirm request from said different terminal apparatus.
